(19) United States
(12) Patent Application Publication
(10) Pub. No.: US 2024/0343902 A1
(43) Pub. Date: Oct. 17, 2024

(54) Laser Transparent Composition and Molded Articles Made Therefrom

(71) Applicant: Celanese International Corporation, Irving, TX (US)

(72) Inventors: Hongyu Chen, Shanghai (CN); Fangfang Tao, Shanghai (CN); Wouter Gabrielse, Sulzbach Am Taunus (DE); Dirk Zierer, Sulzbach Am Taunus (DE)

(21) Appl. No.: 18/683,387

(22) PCT Filed: Aug. 13, 2021
(86) PCT No.: PCT/CN2021/112422

§ 371 Date: Feb. 13, 2024

(51) Int. Cl. C08L 67/02; B29C 65/16; B29K 63/00; B29K 67/00; B29K 309/08; B29L 31/34; C08K 5/00; C08K 5/098; C08K 7/14; G01D 11/24

(52) U.S. Cl. CPC C08L 67/02; B29C 65/1635; C08K 5/0041; C08K 5/098; C08K 7/14; G01D 11/245; B29K 2063/00; B29K 2067/006; B29K 2309/08; B29L 2031/3481; C08L 2201/10; C08L 2203/20

(57) ABSTRACT

Polyester polymer compositions are described containing one or more nucleating agents and optionally reinforcing fibers. The polyester polymer, for instance, can be poly butylene terephthalate. The polymer composition is particularly formulated in order to be substantially transparent at specific wavelengths of light. Consequently, the polyester polymer composition is well suited for use in laser transmission welding in which a laser beam passes through the polymer composition and forms a weld on an adjoining surface. In one aspect, a black pigment masterbatch can be added to the composition for further improving the transparency properties.

### BACKGROUND

Engineering thermoplastics and elastomeric materials are often used in numerous and diverse applications in order to produce molded parts and products. For instance, polyester polymers and polyester elastomers are used to produce all different types of molded products, such as injection molded products, blow molded products, and the like. Polyester polymer compositions, for instance, can be formulated in order to be chemically resistant, to have excellent strength properties and, can be flexible when containing a polyester elastomer. Of particular advantage, polyester polymers can be melt processed due to their thermoplastic nature. In addition, polyester polymers can be recycled and reprocessed.

Polyester polymers are particularly well suited to producing molded articles of any suitable shape or dimension. The molded articles can be made through injection molding, thermoforming, or any other suitable melt processing method. In many applications, the molded article is then bonded to adjacent materials when incorporated into a product or system. Bonding can occur through the use of an adhesive, the use of ultrasonic energy, or using a mechanical fastener. In certain applications, laser welding is the preferred method for bonding or attaching two parts together. The use of laser welding is not only relatively simple but is also very precise and does not typically cause any structural damage to the parts.

In one particular type of laser welding, often referred to as laser transmission welding, two polymer articles are placed in contact with each other and laser energy penetrates and passes through the first molded article and then absorbed by the second article causing a weld to form. In this type of welding, for instance, the first molded article is formulated to be laser-transparent. The first molded article, for instance, should permit a significant portion of the laser light to pass through the article and then be absorbed by the second molded article. When the laser energy contacts the second molded article, the second molded article absorbs the energy, causing a localized increase in temperature which causes the polymer material used to form the second molded article to soften and flow. A weld then forms which can then bond the laser-transparent molded article to the laser-absorbent molded article.

For laser transmission welding to be successful, the laser-transparent molded article should have a relatively high laser transparency at the wavelength at which the laser beam operates. Various efforts have been made in the past to produce molded articles from polyester polymers that have high laser transparency. Problems have been experienced, however, in being able to produce a polyester polymer article having sufficient laser transparency, especially when the polyester polymer composition contains reinforcing fibers. The reinforcing fibers, for instance, can cause significant light scattering, which adversely interferes with the welding process. Thus, a need exists for a fiber reinforced polyester polymer composition that is also transparent to light at a desired wavelength.

### SUMMARY

In general, the present disclosure is directed to a polyester polymer composition containing reinforcing fibers that has excellent transparent properties at certain wavelengths of light. For example, the polymer composition of the present disclosure can be formulated to be laser transparent for use in a laser transmission welding procedure.

In one embodiment, the present disclosure is directed to a laser transparent composition comprising at least one polyester polymer. The polyester polymer can comprise a polybutylene terephthalate polymer. The polybutylene terephthalate polymer, for instance, can be present in the polymer composition in an amount greater than about 40% by weight, such as in an amount greater than about 50% by weight, such as in an amount greater than about 60% by weight, and generally in an amount less than about 85% by weight. The polymer composition further contains reinforcing fibers. The reinforcing fibers can be present in the polymer composition in an amount from about 5% to about 55% by weight, such as in an amount from about 10% to about 38% by weight. The reinforcing fibers can comprise glass fibers.

In accordance with the present disclosure, the polymer composition further contains at least one nucleating agent. The at least one nucleating agent can comprise a benzoate, a salt of a carboxylic acid, or a mixture thereof. The polymer composition can have a laser transparency of at least 40% when measured at a wavelength of 980 nm and at a thickness of 1.5 mm. In addition, the polymer composition can have a tensile strength of greater than about 75 MPa.

In one embodiment, the laser transparent composition contains at least two nucleating agents. The first nucleating agent can comprise the benzoate, while the second nucleating agent can comprise the salt of a carboxylic acid. The salt of a carboxylic acid can be a salt of an aliphatic carboxylic acid having a carbon chain length of from about 16 to about 50 carbon atoms, such as from about 18 to about 30 carbon atoms. The salt of the carboxylic acid can be an alkali or an alkaline earth metal salt of a carboxylic acid. In one aspect, the second nucleating agent can be a sodium salt of a montanic acid. The benzoate, on the other hand, can also comprise an alkali or alkaline earth metal salt of a benzoate. For instance, in one embodiment, the first nucleating agent can comprise sodium benzoate.

In one aspect, each nucleating agent contained in the polymer composition can be present in an amount of less than about 1.5% by weight, and generally in an amount greater than about 0.001% by weight. When a benzoate and a salt of a carboxylic acid are present together, the weight ratio between the benzoate and the salt of the carboxylic acid is from about 1:1 to about 1:4, such as from about 1:1.5 to about 1:3.

In one aspect, the polymer composition can have a laser transparency at a wavelength of 980 nm of about 40% or greater when measured at a thickness of 1.5 mm and can have a transparency of 50% or greater when measured at a thickness of 1 mm. The polymer composition can have a tensile strength of greater than about 75 MPa, such as greater than about 100 MPa, such as greater than about 120 MPa, and generally less than about 400 MPa.

In one embodiment, the polymer composition can also contain a coloring agent. For example, the polymer composition can contain a black pigment or dye and have a black appearance while still retaining excellent laser transparent properties. The black pigment or dye can be present in the polymer composition in an amount from about 0.1% to about 4% by weight.

The present disclosure is also directed to molded articles formed from the polymer composition as described above. The molded article can be laser welded to an adjacent surface or component. In one aspect, the molded article is a housing for a sensor. The sensor, for instance, can be part of an advanced driver assistance system.

The present disclosure is also directed to a method for attaching a polymer article to an adjacent surface. The method includes contacting a molded article made from the laser transparent composition as described above with the laser beam. The laser beam propagates through the molded article and contacts an adjacent surface formed from a laser weldable polymer composition. The laser beam causes a localized temperature increase in the adjacent surface that forms a weld. In one aspect, the weld attaches the molded article to the adjacent surface.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view illustrating a laser welding process that may occur in accordance with the present disclosure.

FIG. 2 is a perspective view illustrating the molded polymer plaque that is crafted to standardize the determination of laser transmission. FIG. 2 shows the minimum different sample locations that will be tested.

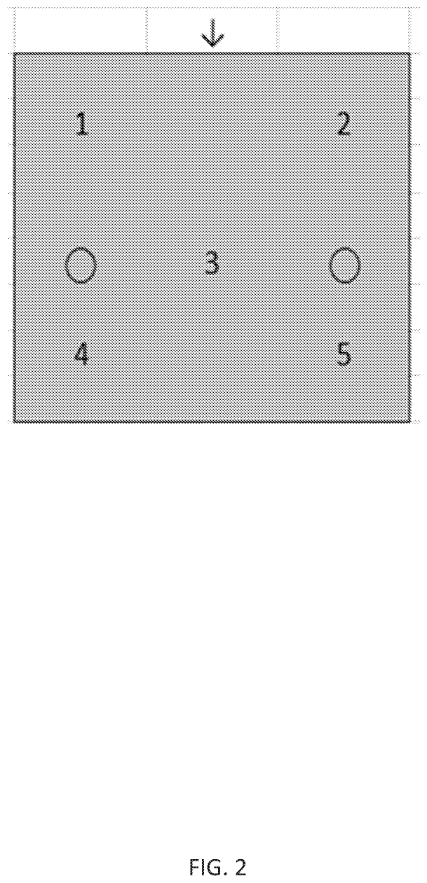

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

Polyester polymer compositions, particularly fiber reinforced polybutylene terephthalate compositions, combine a wide range of desirable physical, mechanical, and electrical properties with excellent chemical and environmental resistance. Polyester compositions are used in all different types of applications and represent one of the fastest growing markets for use in producing advanced drive assistance systems. Polyester compositions, for instance, are well suited for producing all different types of electrical sensors. In these applications, the preferred method for assembling the different components is to use laser welding. For instance, the use of laser transmission welding, for instance, has recently grown significantly in popularity. During laser transmission welding, two joining partners are brought in contact and held together. The assembly includes an upper part and a lower part. The upper part of the assembly is formulated to be transparent to the wavelength at which the irradiating laser operates. The lower part, however, is formulated to be laser absorbent. In this manner, the laser can pass through the upper part and be absorbed by the lower part, which results in localized heating at the interface of the two parts resulting in the melting of both parts due to thermal conduction.

The present disclosure is particularly directed to formulating a polyester composition that is laser transparent and that can also optionally contain reinforcing fibers. Although polyesters, such as polybutylene terephthalate polymers, have excellent and desirable physical properties, the polymers display a transmittance for light in the near infrared range that is considerably lower compared to many other thermoplastic polymers. Consequently, the use of polyester compositions in laser transmission applications has been somewhat limited in the past, especially as the thickness of the parts increase. In addition, the adding of reinforcing fibers further reduces the laser transparency of the polymer. In accordance with the present disclosure, however, it was discovered that adding one or more nucleating agents to the polyester polymer composition can dramatically and unexpectedly improve the laser transparency properties of molded parts made from the composition. Although unknown, it is believed that the nucleating agents produce smaller spherulites which allow near infrared light to pass through. Nucleating agents, however, can have a deleterious effect on the mechanical properties of various polyester polymers. Consequently, the present disclosure is directed to selecting particular nucleating agents at particular amounts for increasing laser transparency without deteriorating the strength of the polymer composition.

The polymer composition of the present disclosure generally contains at least one polyester polymer, optionally reinforcing fibers, and one or more nucleating agents. The polyester polymer can be a polybutylene terephthalate polymer. The polybutylene terephthalate polymer can be present in the polymer composition generally in an amount greater than about 40% by weight, such as in an amount greater than about 50% by weight, such as in an amount greater than about 55% by weight, such as in an amount greater than about 60% by weight, such as in an amount greater than about 65% by weight, and generally in an amount less than about 95% by weight, such as in an amount less than about 90% by weight, such as in an amount less than about 80% by weight.

In one embodiment, the polymer composition only contains a single polyester polymer that is a polybutylene terephthalate polymer. Alternatively, other polyester polymers may be present in the polymer composition. For example, in one aspect, a polybutylene terephthalate polymer can be combined with a polyethylene terephthalate polymer. In addition to at least one polyester polymer, the polymer composition can optionally contain reinforcing fibers, such as glass fibers. In accordance with the present disclosure, the polymer composition further contains one or more nucleating agents. The nucleating agents have been found to dramatically improve the transparency properties of the polymer composition at wavelengths conducive to laser welding without adversely affecting the mechanical properties of molded articles made from polymer composition.

The polymer composition of the present disclosure, for instance, can have a laser transparency of at least about 40% when measured at a wavelength of 980 nm and at a thickness of 1.5 mm. A standardized test for measuring laser transparency is performed by first molding a plaque with the polymer composition having the dimensions of 60 mm×60 mm×1 mm or 1.5 mm. The 980 nm wavelength is produced by the LPKF TMG-3 model transmittance measuring device, which is considered to have a laser transmission of 100% when no obstacle is blocking the path of laser light it transmits. In order to determine the laser transmission of the polymer composition, the plaque of the polymer is placed on the laser detector, and the transmission is tested in at least five different locations. At least two locations close to the inlet, one in the middle, and two far from the inlet are all measured for laser transmission, and all of locations are averaged to determine the final laser transmission of the polymer composition.

For example, the polymer composition can display a transparency of at least 40%, such as at least 42%, such as at least 45%, such as at least 48% at a wavelength of 980 nm and at a thickness of 1.5 mm. When measured at a thickness of 1 mm, the polymer composition of the present disclosure can display a transparency of greater than about 50%, such as greater than about 55%, such as greater than about 60%, such as greater than about 62% at a wavelength of 980 nm. The polymer composition can display the above transparency properties while still having excellent tensile strength. The tensile strength can be varied and controlled based on the amount of reinforcing fibers present in the polymer composition. In general, the polymer composition can display a tensile strength of greater than about 75 MPa. For example, the tensile strength can be greater than about 100 MPa, such as greater than about 120 MPa, such as greater than about 125 MPa, such as greater than about 130 MPa, such as greater than about 135 MPa, such as greater than about 140 MPa, such as greater than about 145 MPa, and generally less than about 300 MPa, such as less than about 200 MPa.

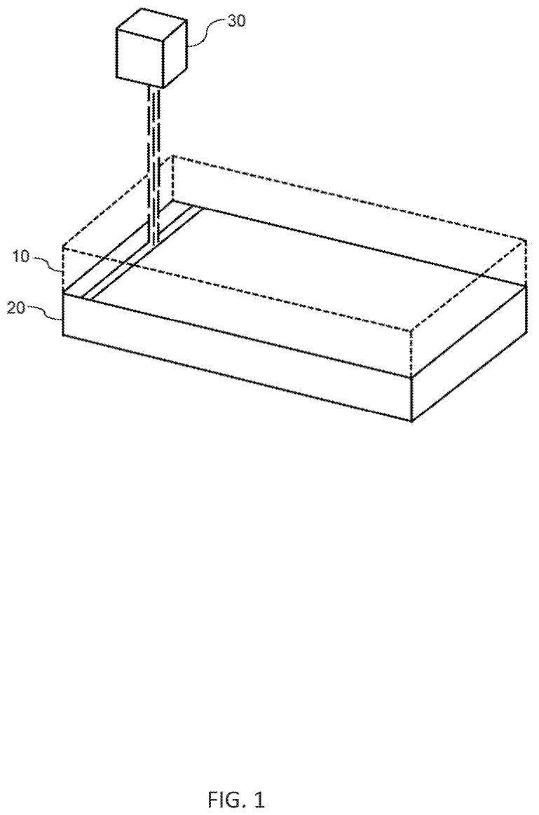

Referring to FIG. 1, for purposes of explanation only, a diagram is presented that displays a transmission welding process. Referring to FIG. 1, an assembly is shown including a first molded part 10 placed adjacent to a second molded part 20. Also illustrated is a laser device 30 that emits a laser beam 40. As shown in FIG. 1, in this embodiment, the laser 30 moves across the width of the first molded part 10 and the second molded part 20. The first molded part 10 is relatively transparent to the laser beam 40 while the second molded part 20 is formulated to absorb the laser beam. In this manner, as shown in FIG. 1, a substantial portion of the laser beam 40 travels through the first molded part 10 and contacts the second molded part 20. The second molded part 20 then absorbs the laser energy and undergoes a localized temperature increase that causes both the first molded part 10 and the second molded part 20 to melt and bond together.

In the embodiment illustrated in FIG. 1, the first molded part 10 is shown to be translucent in order to better illustrate the laser transmission process. Polymer compositions formulated in accordance with the present disclosure, however, can have any suitable color, including a black color.

As described above, the polymer composition generally contains a thermoplastic polymer and particularly a polyester polymer. The polyesters which are suitable for use herein are derived from an aliphatic or cycloaliphatic diol, or mixtures thereof, containing from 2 to about 10 carbon atoms and an aromatic dicarboxylic acid, i.e., polyalkylene terephthalates.

The polyesters which are derived from a cycloaliphatic diol and an aromatic dicarboxylic acid are prepared by condensing either the cis- or trans-isomer (or mixtures thereof) of, for example, 1,4-cyclohexanedimethanol with the aromatic dicarboxylic acid.

Examples of aromatic dicarboxylic acids include isophthalic or terephthalic acid, 1,2-di(p-carboxyphenyl) ethane, 4,4′-dicarboxydiphenyl ether, etc., and mixtures of these. All of these acids contain at least one aromatic nucleus. Fused rings can also be present such as in 1,4- or 1,5- or 2,6-naphthalene-dicarboxylic acids. In one embodiment, the dicarboxylic acid is terephthalic acid or mixtures of terephthalic and isophthalic acid.

Polyesters that may be used in the polymer composition, for instance, include polyethylene terephthalate, polybutylene terephthalate, mixtures thereof and copolymers thereof.

In one aspect, the polyester polymer, such as the polybutylene terephthalate polymer, contains a relatively minimum amount of carboxyl end groups. For instance, the polyester polymer can contain carboxyl end groups in an amount less than about 20 mmol/kg, such as less than about 18 mmol/kg, such as less than about 15 mmol/kg, and generally greater than about 1 mmol/kg. The amount of carboxyl end groups can be minimized on the polyester polymer using different techniques. For example, in one embodiment, the polyester polymer can be contacted with an alcohol, such as benzyl alcohol, for decreasing the amount of carboxyl end groups, or an epoxy resin, such as 2,2-bis(p-glycidyloxyphenyl) propane condensation product with 2,2-bis(p-hydroxyphenyl) propane and similar isomers, respectively phenol, 4,4′-(1-methylethylidene)bis-, polymer with 2,2′-[(I-methylethylidene) bis(4,1-phenyleneoxymethylene)] bis(oxirane).

The polyester polymer or polybutylene terephthalate polymer can generally have a melt flow rate of greater than about 9 cm³/10 min, such as greater than about 15 cm³/10 min, such as greater than about 20 cm³/10 min, and generally less than about 120 cm³/10 min, such as less than about 100 cm³/10 min, such as less than about 70 cm³/10 min, such as less than about 50 cm³/10 min, when tested at 250° C. and at a load of 2.16 kg.

The polymer composition may also contain reinforcing fibers dispersed in the thermoplastic polymer matrix. Reinforcing fibers of which use may advantageously be made are mineral fibers, such as glass fibers or polymer fibers, in particular organic high-modulus fibers, such as aramid fibers.

These fibers may be in a modified or unmodified form, e.g. provided with a sizing, or chemically treated, in order to improve adhesion to the plastic. Glass fibers are particularly preferred.

The reinforcing fibers, such as the glass fibers, can be coated with a sizing composition to protect the fibers and to improve the adhesion between the fiber and the matrix material. A sizing composition usually comprises silanes, film forming agents, lubricants, wetting agents, adhesive agents, optionally antistatic agents and plasticizers, emulsifiers and optionally further additives.

Specific examples of silanes are aminosilanes, e.g. 3-trimethoxysilylpropylamine, N-(2-aminoethyl)-3-aminopropyltrimethoxy-silane, N-(3-trimethoxysilanylpropyl) ethane-1,2-diamine, 3-(2-aminoethyl-amino) propyltrimethoxysilane, N-[3-(trimethoxysilyl) propyl]-1,2-ethane-diamine.

Film forming agents are for example polyvinylacetates, polyesters and polyurethanes.

The sizing composition applied to the reinforcing fibers can contain not only a silane sizing agent but can also contain a hydrolysis resistant agent. The hydrolysis resistant agent, for instance, can be a glycidyl ester type epoxy resin. For instance, the glycidyl ester type epoxy resin can be a monoglycidyl ester or a diglycidyl ester. Examples of glycidyl ester type epoxy resins that may be used include acrylic acid glycidyl ester, a methacrylic acid glycidyl ester, a phthalic acid diglycidyl ester, a methyltetrahydrophthalic acid diglycidyl ester, or mixtures thereof.

In one aspect, the sizing composition contains a silane, a glycidyl ester type epoxy resin, a second epoxy resin, a urethane resin, an acrylic resin, a lubricant, and an antistatic agent. The second type of epoxy resin, for instance, can be a bisphenol A type epoxy resin. The hydrolysis resistant agent can be present in the sizing composition in relation to the silane sizing agent at a weight ratio of from about 5:1 to about 1:1, such as from about 4:1 to about 2:1.

The reinforcing fibers may be compounded into the polymer matrix, for example in an extruder or kneader.

Fiber diameters can vary depending upon the particular fiber used and whether the fiber is in either a chopped or a continuous form. The fibers, for instance, can have a diameter of from about 5 μm to about 100 μm, such as from about 5 μm to about 50 μm, such as from about 5 μm to about 12 μm. The length of the fibers can vary depending upon the particular application. For instance, the fibers can have an average length of greater than about 0.5 mm, such as greater than about 1 mm, such as greater than about 1.5 mm, such as greater than about 2.5 mm. The length of the fibers can generally be less than about 8 mm, such as less than about 7 mm, such as less than about 5.5 mm, such as less than about 4 mm.

In general, reinforcing fibers are present in the polymer composition in amounts sufficient to increase the tensile strength of the composition. The reinforcing fibers, for example, can be present in the polymer composition in an amount greater than about 2% by weight, such as in an amount greater than about 5% by weight, such as in an amount greater than about 10% by weight, such as in an amount greater than about 15% by weight, such as in an amount greater than about 20% by weight. The reinforcing fibers are generally present in an amount less than about 55% by weight, such as in an amount less than about 50% by weight, such as in an amount less than about 45% by weight, such as in an amount less than about 40% by weight, such as in an amount less than about 35% by weight, such as in an amount less than about 30% by weight.

In addition to one or more thermoplastic polymers and optionally reinforcing fibers, the polymer composition of the present disclosure contains one or more nucleating agents. For example, one nucleating agent that has been found to be particularly well suited for use in the polymer composition of the present disclosure is a benzoate, particularly a benzoate salt. The benzoate, for instance, can be an alkali or alkaline earth metal salt of benzoic acid. In one aspect, the nucleating agent can be sodium benzoate.

Another nucleating agent that has been found particularly well suited for use in the present disclosure is a salt of one or more carboxylic acids, such as a salt of one or more fatty acids. For example, the nucleating agent can comprise a salt of one or more aliphatic carboxylic acids. The carboxylic acids can have a relatively long carbon chain length. For instance, the carboxylic acids can have a carbon chain length of from about 14 carbon atoms to about 50 carbon atoms, such as from about 24 carbon atoms to about 34 carbon atoms. The carboxylic acids can be aliphatic and linear. The salt of the carboxylic acids can be an alkali or alkaline earth metal salt.

In one particular embodiment, the nucleating agent can be a salt of montanic acid, such as a sodium salt of montanic acid and/or a calcium salt of montanic acid. The montanic acid may include a blend of carboxylic acids having a carbon chain length of from about 24 carbon atoms to about 34 carbon atoms, such as from about 28 carbon atoms to about 32 carbon atoms.

In one embodiment, the nucleating agent is a sodium salt of a phosphorus compound. Suitable types of sodium salt nucleating agents include 2,4,8,10-Tetra(tert-buty)-6-hydroxy-12H-dibenzo[d,g] [1,3,2] dioxaphosphocin 6-oxide, sodium salt. Commercially available examples of such suitable sodium salts may be obtained from the Adeka Corp. under the designation ADK STAB NA-11, and have the following general structure:

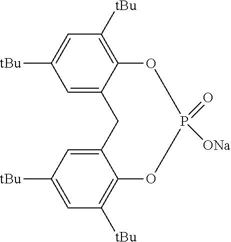

In one aspect, the nucleating agent can comprise a sorbitol type of nucleating agent. Sorbitol-based nucleating agents include 1,3:2,4 Dibenzylidene sorbitol, 1,3:2,4 Di(methylbenzylidene) sorbitol, 1,3:2,4 Di(ethylbenzylidene) sorbitol, and 1,3:2,4 Bis(3,4-dimethylbenzylidene) sorbitol. Suitable sorbitol types of nucleating agents can include Miliken NX 8000i, which is commercially available from Miliken Chemical Company.

Each nucleating agent can be present in the polymer composition in an amount less than about 3% by weight, such as in an amount less than about 1.5% by weight, such as in an amount less than about 1.2% by weight, such as in an amount less than about 0.8% by weight, and generally in an amount greater than about 0.05% by weight, such as in an amount greater than about 0.1% by weight, such as in an amount greater than about 0.15% by weight.

In one particular embodiment, the polymer composition contains more than one nucleating agent. For example, the polymer composition can contain a benzoate salt, such as sodium benzoate in combination with a salt of one or more carboxylic acids as described above. In one aspect, the salt of one or more carboxylic acids can be present in the polymer composition in an amount greater than the amount of sodium benzoate present. For example, the weight ratio between the salt of one or more carboxylic acids and the sodium benzoate can be from about 4:1 to about 1:1, such as from about 3:1 to about 1.5:1. In one particular embodiment, the ratio between the salt of one or more carboxylic acids and the sodium benzoate is from about 2.5:1 to about 1.5:1.

In one aspect, the polyester polymer composition can contain a carbodiimide compound. The carbodiimide compound can have a carbodiimide group (—N═C═N—) in the molecule. The carbodiimide compound can provide hydrolysis resistance. Applicable carbodiimide compounds include an aliphatic carbodiimide compound having an aliphatic main chain, an alicyclic carbodiimide compound having an alicyclic main chain, and an aromatic carbodiimide compound having an aromatic main chain.

Examples of the aliphatic carbodiimide compounds include diisopropyl carbodiimide, dioctyldecyl carbodiimide, or the like. An example of the alicyclic carbodiimide compound includes dicyclohexyl carbodiimide, or the like.

Examples of aromatic carbodiimide compounds include: a mono- or di-carbodiimide compound such as diphenyl carbodiimide, di-2,6-dimethylphenyl carbodiimide, N-tolyl-N′-phenyl carbodiimide, di-p-nitrophenyl carbodiimide, di-p-aminophenyl carbodiimide, di-p-hydroxyphenyl carbodiimide, di-p-chlorophenyl carbodiimide, di-p-methoxyphenyl carbodiimide, di-3,4-dichlorophenyl carbodiimide, di-2,5-dichlorophenyl carbodiimide, di-o-chlorophenyl carbodiimide, p-phenylene-bis-di-o-tolyl carbodiimide, p-phenylene-bis-dicyclohexyl carbodiimide, p-phenylene-bis-di-p-chlorophenyl carbodiimide or ethylene-bis-diphenyl carbodiimide; and a polycarbodiimide compound such as poly(4,4′-diphenylmethane carbodiimide), poly(3,5′-dimethyl-4,4′-biphenylmethane carbodiimide), poly(p-phenylene carbodiimide), poly(m-phenylene carbodiimide), poly(3,5′-dimethyl-4,4′-diphenylmethane carbodiimide), poly(naphthylene carbodiimide), poly(1,3-diisopropylphenylene carbodiimide), poly(1-methyl-3,5-diisopropylphenylene carbodiimide), poly(1,3,5-triethylphenylene carbodiimide) or poly(triisopropylphenylene carbodiimide). These compounds can be used in combination of two or more of them. Among these, specifically preferred ones to be used are di-2,6-dimethylphenyl carbodiimide, poly(4,4′-diphenylmethane carbodiimide), poly(phenylene carbodiimide), and poly(triisopropylphenylene carbodiimide).

In one aspect, the carbodiimide compound is a polycarbodiimide. For instance, the polycarbodiimide can have a weight average molecular weight of about 10,000 g/mol or greater and generally less than about 100,000 g/mol. Examples of polycarbodiimides include Stabaxol KE9193 and Stabaxol P100 by Lanxess and Lubio AS3-SP by Schaeffe Additive Systems.

The carbodiimide compound can be present in the polymer composition in an amount greater than about 0.3% by weight, such as in an amount greater than about 0.8% by weight, and generally in an amount less than about 4% by weight, such as in an amount less than about 3% by weight, such as in an amount less than about 1.8% by weight.

Of particular advantage, the polymer composition of the present disclosure can also contain one or more coloring agents and still retain the desired laser transparent properties. The coloring agent can be a dye, a pigment, or combinations thereof. The polymer composition can be formulated to have any suitable color. In one aspect, for instance, the polymer composition can be formulated to have a black color or appearance.

In one embodiment, one or more coloring agents can be added to the polymer composition as a masterbatch. In one aspect, the masterbatch can contain a black dye in an amount from about 30% to about 70% by weight. The black dye can be any suitable black coloring agent, including Clariant's RENOL NB 93447125. The addition of the black coloring agent to the masterbatch does not deteriorate the laser transparency. When added to the polymer composition as a masterbatch, the coloring agent can be combined with a carrier, such as a carrier polymer. In one aspect, the carrier can be a copolyester elastomer.

Each coloring agent can be present in the polymer composition generally in an amount less than about 3% by weight, such as in an amount less than about 2% by weight, such as in an amount less than about 1% by weight, and generally in an amount greater than about 0.01% by weight, such as in an amount greater than about 0.1% by weight. When added as a masterbatch, the masterbatch can be added to the polymer composition generally in an amount from about 1% to about 5% by weight.

The polymer composition may also contain one or more lubricants. For instance, fatty acid esters may be present as lubricants. Fatty acid esters may be obtained by oxidative bleaching of a crude natural wax and subsequent esterification of the fatty acids with an alcohol. The alcohol typically has 1 to 4 hydroxyl groups and 2 to 20 carbon atoms. When the alcohol is multifunctional (e.g., 2 to 4 hydroxyl groups), a carbon atom number of 2 to 8 is particularly desired. Particularly suitable multifunctional alcohols may include dihydric alcohol (e.g., ethylene glycol, propylene glycol, butylene glycol, 1,3-propanediol, 1,4-butanediol, 1,6-hexanediol and 1,4-cyclohexanediol), trihydric alcohol (e.g., glycerol and trimethylolpropane), tetrahydric alcohols (e.g., pentaerythritol and erythritol), and so forth. Aromatic alcohols may also be suitable, such as o-, m- and p-tolylcarbinol, chlorobenzyl alcohol, bromobenzyl alcohol, 2,4-dimethylbenzyl alcohol, 3,5-dimethylbenzyl alcohol, 2,3,5-cumobenzyl alcohol, 3,4,5-trimethylbenzyl alcohol, p-cuminyl alcohol, 1,2-phthalyl alcohol, 1,3-bis(hydroxymethyl)benzene, 1,4-bis(hydroxymethyl)benzene, pseudocumenyl glycol, mesitylene glycol and mesitylene glycerol. Particularly suitable fatty acid esters for use in the present invention are derived from montanic waxes. For instance, montanic acids can be partially esterified with butylene glycol and montanic acids can be partially saponified with calcium hydroxide. In one aspect, the lubricant can be an ester of a montanic acid in combination with a polyol.

Other known waxes may also be employed as a lubricant. Amide waxes, for instance, may be employed that are formed by reaction of a fatty acid with a monoamine or diamine (e.g., ethylenediamine) having 2 to 18, especially 2 to 8, carbon atoms. For example, ethylenebisamide wax, which is formed by the amidization reaction of ethylene diamine and a fatty acid, may be employed. The fatty acid may be in the range from C₁₂ to C₃₀, such as from stearic acid (C₁₈ fatty acid) to form ethylenebisstearamide wax. Ethylenebisstearamide wax is commercially available from Lonza, Inc. under the designation Acrawax® C, which has a discrete melt temperature of 142° C. Other ethylenebisamides include the bisamides formed from lauric acid, palmitic acid, oleic acid, linoleic acid, linolenic acid, oleostearic acid, myristic acid and undecalinic acid. Still other suitable amide waxes are N-(2-hydroxyethyl) 12-hydroxystearamide and N,N′-(ethylene bis) 12-hydroxystearamide, which are commercially available from CasChem, a division of Rutherford Chemicals LLC, under the designations Paricin® 220 and Paricin® 285, respectively. Other waxes that may be used include polyethylene waxes.

One or more lubricants can be present in the polymer composition generally in an amount greater than about 0.1% by weight, such as in an amount greater than about 0.2% by weight, such as in an amount greater than about 0.8% by weight, such as in an amount greater than about 1% by weight. One or more lubricants are generally present in an amount less than about 5% by weight, such as in an amount less than about 4% by weight, such as in an amount less than about 3.5% by weight.

The polymer composition of the present disclosure can contain various other additives. For example, the polymer composition may contain at least one stabilizer. The stabilizer may comprise an antioxidant, a light stabilizer such as an ultraviolet light stabilizer, a thermal stabilizer, and the like.

Sterically hindered phenolic antioxidant(s) may be employed in the composition. Examples of such phenolic antioxidants include, for instance, calcium bis(ethyl 3,5-di-tert-butyl-4-hydroxybenzylphosphonate) (Irganox® 1425); terephthalic acid, 1,4-dithio-, S,S-bis(4-tert-butyl-3-hydroxy-2,6-dimethylbenzyl) ester (Cyanox® 1729); triethylene glycol bis(3-tert-butyl-4-hydroxy-5-methylhydrocinnamate); hexamethylene bis(3,5-di-tert-butyl-4-hydroxyhydrocinnamate (Irganox® 259); 1,2-bis(3,5,di-tert-butyl-4-hydroxyhydrocinnamoyl) hydrazide (Irganox® 1024); 4,4′-di-tert-octyldiphenamine (Naugalube@ 438R); phosphonic acid, (3,5-di-tert-butyl-4-hydroxybenzyl)-, dioctadecyl ester (Irganox® 1093); 1,3,5-trimethyl-2,4,6-tris(3′,5′-di-tert-butyl-4′ hydroxybenzyl)benzene (Irganox® 1330); 2,4-bis(octylthio)-6-(4-hydroxy-3,5-di-tert-butylanilino)-1,3,5-triazine (Irganox® 565); isooctyl 3-(3,5-di-tert-butyl-4-hydroxyphenyl) propionate (Irganox® 1135); octadecyl 3-(3,5-di-tert-butyl-4-hydroxyphenyl) propionate (Irganox® 1076); 3,7-bis(1,1,3,3-tetramethylbutyl)-10H-phenothiazine (Irganox® LO 3); 2,2′-methylenebis(4-methyl-6-tert-butylphenol) monoacrylate (Irganox® 3052); 2-tert-butyl-6-[1-(3-tert-butyl-2-hydroxy-5-methylphenyl)ethyl]-4-methylphenyl acrylate (Sumilizer® TM 4039); 2-[1-(2-hydroxy-3,5-di-tert-pentylphenyl)ethyl]-4,6-di-tert-pentylphenyl acrylate (Sumilizer® GS); 1,3-dihydro-2H-Benzimidazole (Sumilizer® MB); 2-methyl-4,6-bis[(octylthio)methyl] phenol (Irganox® 1520); N,N′-trimethylenebis-[3-(3,5-di-tert-butyl-4-hydroxyphenyl) propionamide (Irganox® 1019); 4-n-octadecyloxy-2,6-diphenylphenol (Irganox® 1063); 2,2′-ethylidenebis[4,6-di-tert-butylphenol] (Irganox® 129); N N′-hexamethylenebis(3,5-di-tert-butyl-4-hydroxyhydrocinnamamide) (Irganox® 1098); diethyl(3,5-di-tert-butyl-4-hydroxybenxyl)phosphonate (Irganox® 1222); 4,4′-di-tert-octyldiphenylamine (Irganox® 5057); N-phenyl-1-napthalenamine (Irganox® L 05); tris[2-tert-butyl-4-(3-ter-butyl-4-hydroxy-6-methylphenylthio)-5-methyl phenyl] phosphite (Hostanox® OSP 1); zinc dinonyidithiocarbamate (Hostanox® VP-ZNCS 1); 3,9-bis[1,1-dimethyl-2-[(3-tert-butyl-4-hydroxy-5-methylphenyl) propionyloxy] ethyl]-2,4,8,10-tetraoxaspiro[5.5] undecane (Sumilizer® AG80); pentaerythrityl tetrakis[3-(3,5-di-tert-butyl-4-hydroxyphenyl) propionate] (Irganox® 1010); ethylene-bis(oxyethylene)bis[3-(5-tert-butyl-4-hydroxy-m-tolyl)-propionate (Irganox® 245); 3,5-di-tert-butyl-4-hydroxytoluene (Lowinox BHT, Chemtura) and so forth.

Some examples of suitable sterically hindered phenolic antioxidants for use in the present composition are triazine antioxidants having the following general formula:

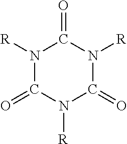

wherein, each R is independently a phenolic group, which may be attached to the triazine ring via a C₁ to C₅ alkyl or an ester substituent. Preferably, each R is one of the following formula (I)-(III):

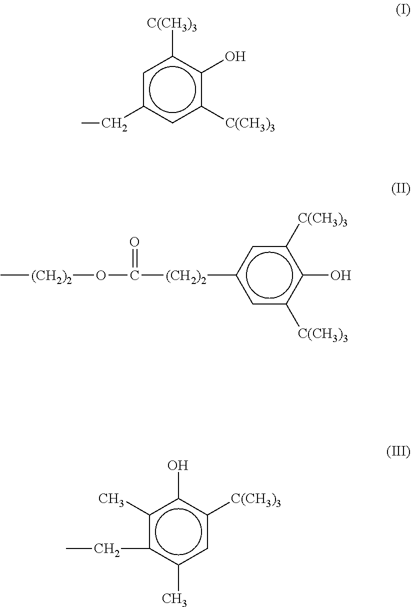

Commercially available examples of such triazine-based antioxidants may be obtained from American Cyanamid under the designation Cyanox® 1790 (wherein each R group is represented by the Formula III) and from Ciba Specialty Chemicals under the designations Irganox® 3114 (wherein each R group is represented by the Formula I) and Irganox® 3125 (wherein each R group is represented by the Formula II).

Sterically hindered phenolic antioxidants may constitute from about 0.01 wt. % to about 3 wt. %, in some embodiments from about 0.05 wt. % to about 1 wt. %, and in some embodiments, from about 0.05 wt. % to about 0.1 wt. % of the entire stabilized polymer composition. In one embodiment, for instance, the antioxidant comprises pentaerythrityl tetrakis[3-(3,5-di-tert-butyl-4-hydroxyphenyl) propionate.

Hindered amine light stabilizers (“HALS”) may be employed in the composition to inhibit degradation of the polyester composition and thus extend its durability. Suitable HALS compounds may be derived from a substituted piperidine, such as alkyl-substituted piperidyl, piperidinyl, piperazinone, alkoxypiperidinyl compounds, and so forth. For example, the hindered amine may be derived from a 2,2,6,6-tetraalkylpiperidinyl. Regardless of the compound from which it is derived, the hindered amine is typically an oligomeric or polymeric compound having a number average molecular weight of about 1,000 or more, in some embodiments from about 1000 to about 20,000, in some embodiments from about 1500 to about 15,000, and in some embodiments, from about 2000 to about 5000. Such compounds typically contain at least one 2,2,6,6-tetraalkylpiperidinyl group (e.g., 1 to 4) per polymer repeating unit.

Without intending to be limited by theory, it is believed that high molecular weight hindered amines are relatively thermostable and thus able to inhibit light degradation even after being subjected to extrusion conditions. One particularly suitable high molecular weight hindered amine has the following general structure:

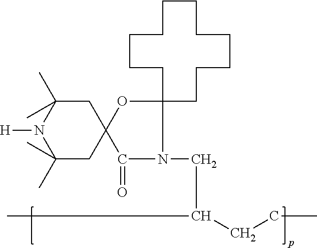

wherein, p is 4 to 30, in some embodiments 4 to 20, and in some embodiments 4 to 10. This oligomeric compound is commercially available from Clariant under the designation Hostavin® N30 and has a number average molecular weight of 1200.

Another suitable high molecular weight hindered amine has the following structure:

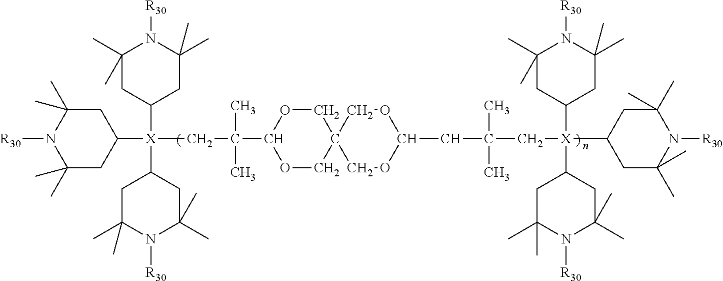

wherein, n is from 1 to 4 and R₃₀ is independently hydrogen or CHs. Such oligomeric compounds are commercially available from Adeka Palmarole SAS (joint venture between Adeka Corp. and Palmarole Group) under the designation ADK STAB® LA-63 (R₃₀ is CH₃) and ADK STAB® LA-68 (R₃₀ is hydrogen).

Other examples of suitable high molecular weight hindered amines include, for instance, an oligomer of N-(2-hydroxyethyl)-2,2,6,6-tetramethyl-4-piperidinol and succinic acid (Tinuvin® 622 from Ciba Specialty Chemicals, MW=4000); oligomer of cyanuric acid and N,N-di(2,2,6,6-tetramethyl-4-piperidyl)-hexamethylene diamine; poly((6-morpholine-S-triazine-2,4-diyl) (2,2,6,6-tetramethyl-4-piperidinyl)-iminohexamethylene-(2,2,6,6-tetramethyl-4-piperidinyl)-imino) (Cyasorb® UV 3346 from Cytec, MW=1600); polymethylpropyl-3-oxy-[4 (2,2,6,6-tetramethyl)-piperidinylysiloxane (Uvasil® 299 from Great Lakes Chemical, MW=1100 to 2500); copolymer of a-methylstyrene-N-(2,2,6,6-tetramethyl-4-piperidinyl) maleimide and N-stearyl maleimide; 2,4,8,10-tetraoxaspiro[5.5] undecane-3,9-diethanol tetramethyl-polymer with 1,2,3,4-butanetetracarboxylic acid; and so forth. Still other suitable high molecular weight hindered amines are described in U.S. Pat. No. 5,679,733 to Malik, et al. and 6,414,155 to Sassi, et al., which are incorporated herein in their entirety by reference thereto for all purposes.

In addition to the high molecular hindered amines, low molecular weight hindered amines may also be employed in the composition. Such hindered amines are generally monomeric in nature and have a molecular weight of about 1000 or less, in some embodiments from about 155 to about 800, and in some embodiments, from about 300 to about 800.

Specific examples of such low molecular weight hindered amines may include, for instance, bis-(2,2,6,6-tetramethyl-4-piperidyl) sebacate (Tinuvin® 770 from Ciba Specialty Chemicals, MW=481); bis-(1,2,2,6,6-pentamethyl-4-piperidinyl)-(3,5-ditert.butyl-4-hydroxybenzyl)butyl-propane dioate; bis-(1,2,2,6,6-pentamethyl-4-piperidinyl) sebacate; 8-acetyl-3-dodecyl-7,7,9,9-tetramethyl-1,3,8-triazaspiro-(4,5)-decane-2,4-dione, butanedioic acid-bis-(2,2,6,6-tetramethyl-4-piperidinyl) ester; tetrakis-(2,2,6,6-tetramethyl-4-piperidyl)-1,2,3,4-butane tetracarboxylate; 7-oxa-3,20-diazadispiro(5.1.11.2) heneicosan-20-propanoic acid, 2,2,4,4-tetramethyl-21-oxo, dodecyl ester; N-(2,2,6,6-tetramethyl-4-piperidinyl)-N′-amino-oxamide; o-t-amyl-o-(1,2,2,6,6-pentamethyl-4-piperidinyl)-monoperoxi-carbonate; B-alanine, N-(2,2,6,6-tetramethyl-4-piperidinyl), dodecylester; ethanediamide, N-(1-acetyl-2,2,6,6-tetramethylpiperidinyl)-N′-dodecyl; 3-dodecyl-1-(2,2,6,6-tetramethyl-4-piperidinyl)-pyrrolidin-2,5-dione; 3-dodecyl-1-(1,2,2,6,6-pentamethyl-4-piperidinyl)-pyrrolidin-2,5-dione; 3-dodecyl-1-(1-acetyl,2,2,6,6-tetramethyl-4-piperidinyl)-pyrrolidin-2,5-dione, (Sanduvar® 3058 from Clariant, MW=448.7); 4-benzoyloxy-2,2,6,6-tetramethylpiperidine; 1-[2-(3,5-di-tert-butyl-4-hydroxyphenylpropionyloxy)ethyl]-4-(3,5-di-tert-butyl-4-hydroxylphenyl propionyloxy)-2,2,6,6-tetramethyl-piperidine; 2-methyl-2-(2″,2″,6″,6″-tetramethyl-4″-piperidinylamino)-N-(2′,2′,6′,6′-tetra-methyl-4′-piperidinyl) propionylamide; 1,2-bis-(3,3,5,5-tetramethyl-2-oxo-piperazinyl) ethane; 4-oleoyloxy-2,2,6,6-tetramethylpiperidine; and combinations thereof. Other suitable low molecular weight hindered amines are described in U.S. Pat. No. 5,679,733 to Malik, et al.

The hindered amines may be employed singularly or in combination in any amount to achieve the desired properties, but typically constitute from about 0.01 wt. % to about 4 wt. % of the polymer composition.

UV absorbers, such as benzotriazoles or benzopheones, may be employed in the composition to absorb ultraviolet light energy. Suitable benzotriazoles may include, for instance, 2-(2-hydroxyphenyl)benzotriazoles, such as 2-(2-hydroxy-5-methylphenyl)benzotriazole; 2-(2-hydroxy-5-tert-octylphenyl)benzotriazole (Cyasorb® UV 5411 from Cytec); 2-(2-hydroxy-3,5-di-tert-butylphenyl)-5-chlorobenzo-triazole; 2-(2-hydroxy-3-tert-butyl-5-methylphenyl)-5-chlorobenzotriazole; 2-(2-hydroxy-3,5-dicumylphenyl)benzotriazole; 2,2′-methylenebis(4-tert-octyl-6-benzo-triazolylphenol): polyethylene glycol ester of 2-(2-hydroxy-3-tert-butyl-5-carboxyphenyl)benzotriazole; 2-[2-hydroxy-3-(2-acryloyloxyethyl)-5-methylphenyl]-benzotriazole; 2-[2-hydroxy-3-(2-methacryloyloxyethyl)-5-tert-butylphenyl] benzotriazole; 2-[2-hydroxy-3-(2-methacryloyloxyethyl)-5-tert-octylphenyl] benzotriazole; 2-[2-hydroxy-3-(2-methacryloyloxyethyl)-5-tert-butylphenyl]-5-chlorobenzotriazole; 2-[2-hydroxy-5-(2-methacryloyloxyethyl)phenyl] benzotriazole; 2-[2-hydroxy-3-tert-butyl-5-(2-methacryloyloxyethyl)phenyl] benzotriazole; 2-[2-hydroxy-3-tert-amyl-5-(2-methacryloyloxyethyl)phenyl] benzotriazole; 2-[2-hydroxy-3-tert-butyl-5-(3-methacryloyloxypropyl)phenyl]-5-chlorobenzotriazole; 2-[2-hydroxy-4-(2-methacryloyloxymethyl)phenyl] benzotriazole; 2-[2-hydroxy-4-(3-methacryloyloxy-2-hydroxypropyl)phenyl] benzotriazole; 2-[2-hydroxy-4-(3-methacryloyloxypropyl)phenyl] benzotriazole; and combinations thereof.

Exemplary benzophenone light stabilizers may likewise include 2-hydroxy-4-dodecyloxybenzophenone: 2,4-dihydroxybenzophenone; 2-(4-benzoyl-3-hydroxyphenoxy)ethyl acrylate (Cyasorb® UV 209 from Cytec); 2-hydroxy-4-n-octyloxy)benzophenone (Cyasorb@ 531 from Cytec); 2,2′-dihydroxy-4-(octyloxy)benzophenone (Cyasorb® UV 314 from Cytec); hexadecyl-3,5-bis-tert-butyl-4-hydroxybenzoate (Cyasorb® UV 2908 from Cytec); 2,2′-thiobis(4-tert-octylphenolato)-n-butylamine nickel (II) (Cyasorb® UV 1084 from Cytec); 3,5-di-tert-butyl-4-hydroxybenzoic acid, (2,4-di-tert-butylphenyl) ester (Cyasorb®) 712 from Cytec); 4,4′-dimethoxy-2,2′-dihydroxybenzophenone (Cyasorb® UV 12 from Cytec); and combinations thereof.

When employed. UV absorbers may constitute from about 0.01 wt. % to about 4 wt. % of the entire polymer composition.

Once formed, the polymer composition may be molded into a shaped part for use in a wide variety of different applications. For example, the shaped part may be molded using an injection molding process in which dried and preheated plastic granules can be injected into the mold.

The polymer composition and/or shaped molded part can be used in a variety of applications. For example, the molded part can be employed in lighting assemblies, battery systems, sensors and electronic components, portable electronic devices such as smart phones, MP3 players, mobile phones, computers, televisions, automotive parts, etc. In one particular embodiment, the molded part may be employed in a camera module, such as those commonly employed in wireless communication devices (e.g., cellular telephone). For example, the camera module may employ a base, carrier assembly mounted on the base, a cover mounted on the carrier assembly, etc. The base may have a thickness of about 500 micrometers or less, in some embodiments from about 10 to about 450 micrometers, and in some embodiments, from about 20 to about 400 micrometers. Likewise, the carrier assembly may have a wall thickness of about 500 micrometers or less, in some embodiments from about 10 to about 450 micrometers, and in some embodiments, from about 20 to about 400 micrometers.

In one aspect, the polymer composition of the present disclosure can be used to produce a housing for electronic devices. For instance, the polymer composition can be a housing for a sensor. In one particular embodiment, the sensor can be part of an advanced driver assistance system.

As described above, polymer articles made according to the present disclosure are particularly well suited for use in applications where laser transmission welding is utilized. Polymer articles made according to the present disclosure, for instance, have high transparency properties at wavelengths at which lasers operates. During laser welding, for instance, a laser beam can travel through molded articles made according to the present disclosure and contact an adjacent surface for forming a weld. The laser beam causes a localized temperature increase at the adjacent surface which causes polymer melting to occur and the formation of a weld. Of particular advantage, molded articles made according to the present disclosure are not only laser transparent but also have excellent mechanical properties. All different types of laser beams can be used during the laser transmission process. The laser, for instance, can be a laser diode.

The laser beam, for instance, can operate at a wavelength of light of greater than about 400 nm, such as greater than about 600 nm, such as greater than about 800 nm, and generally less than about 2000 nm, such as less than about 1800 nm.

The present disclosure may be better understood with reference to the following examples.

### EXAMPLES

Various different polymer compositions were formulated and tested for laser transmission and tensile strength. Tensile strength was measured according to ISO Test 527-2/1A at a rate of 5 mm/min (tensile stress at break).

The following sample formulations were tested and the following results were obtained:

| | Sam- | Sam- | Sam- | Sam- | Sam- | Sam- | Sam- |
|---|---|---|---|---|---|---|---|
| | ple | ple | ple | ple | ple | ple | ple |
| Component | No. 1 | No. 2 | No. 3 | No. 4 | No. 5 | No. 6 | No. 7 |
| Polybutylene | 68.1 | 67.6 | 67.35 | 65.35 | 67.9 | 67.5 | 67.5 |
| Terephthalate | | | | | | | |
| Polymer | | | | | | | |
| Glass fibers | 30 | 30 | 30 | 30 | 30 | 30 | 30 |
| Epon (epoxy | 1.5 | 1.5 | 1.5 | 1.5 | 1.5 | 1.5 | 1.5 |
| resin) | | | | | | | |
| Phenolic | 0.2 | 0.2 | 0.2 | 0.2 | 0.2 | 0.2 | 0.2 |
| Antioxidant | | | | | | | |
| Thioether | 0.2 | 0.2 | 0.2 | 0.2 | 0.2 | 0.2 | 0.2 |
| Antioxidant | | | | | | | |
| Sodium | | 0.5 | 0.25 | | 0.2 | 0.2 | 0.2 |
| Benzoate | | | | | | | |
| Sodium salt of | | | 0.5 | | | | |
| aliphatic | | | | | | | |
| carboxylic | | | | | | | |
| acids | | | | | | | |
| ADK STAB | | | | | | | 0.4 |
| NA-11 | | | | | | | |
| (Sodium salt | | | | | | | |
| nucleating | | | | | | | |
| agent) | | | | | | | |
| Milliken NX | | | | | | 0.4 | |
| 8000i (Sorbital | | | | | | | |
| nucleating | | | | | | | |
| agent) | | | | | | | |
| Masterbatch | | | | 2 | | | |
| containing | | | | | | | |
| black coloring | | | | | | | |
| agent and | | | | | | | |
| copolyester | | | | | | | |
| polymer | | | | | | | |

The above formulations were molded into test plaques and the following results were obtained.

| | Sam- | Sam- | Sam- | Sam- | Sam- | Sam- | Sam- |
|---|---|---|---|---|---|---|---|
| | ple | ple | ple | ple | ple | ple | ple |
| Properties | No. 1 | No. 2 | No. 3 | No. 4 | No. 5 | No. 6 | No. 7 |
| Laser | N.A. | N.A. | 47% | 50% | 42% | 46% | 47% |
| Transmission | | | | | | | |
| (1 mm | | | | | | | |
| thickness) | | | | | | | |
| Laser | 9% | 46% | 57% | 63% | 31% | 35% | 34% |
| Transmission | | | | | | | |
| (1.5 mm | | | | | | | |
| thickness) | | | | | | | |
| Tensile | 142.2 | 105.7 | 145 | 148.25 | 145.88 | 148.02 | 152.4 |
| strength at | MPa | MPa | MPa | MPa | MPa | MPa | MPa |
| break, 5 | | | | | | | |
| mm/min | | | | | | | |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

1. A laser transparent composition comprising:
a polymer composition comprising a polyester polymer, the polyester polymer comprising a polybutylene terephthalate polymer, the polymer composition further comprising reinforcing fibers and at least one nucleating agent, the reinforcing fibers being present in the polymer composition in an amount from about 5% to about 55% by weight, the at least one nucleating agent comprising a benzoate, a salt of a carboxylic acid, a sorbitol, a sodium salt of a phosphorus compound or mixtures thereof, the polymer composition having a laser transparency of at least 40% when measured at a wavelength of 980 nm and at a thickness of 1.5 mm.

2. A laser transparent composition as defined in claim 1, wherein the polymer composition contains a mixture of nucleating agents.

3. A laser transparent composition as defined in claim 1, wherein the polymer composition contains a benzoate and a salt of a carboxylic acid.

4. A laser transparent composition as defined in claim 1, wherein the polymer composition contains the salt of a carboxylic acid, the carboxylic acid comprising an aliphatic carboxylic acid having a carbon chain length of from about 14 carbon atoms to about 50 carbon atoms, the salt of a carboxylic acid comprising an alkali or alkaline earth metal salt of a carboxylic acid.

5. A laser transparent composition as defined in claim 4, wherein the salt of the carboxylic acid is a sodium salt of the carboxylic acid.

6. A laser transparent composition as defined in claim 1, wherein the polymer composition contains the benzoate, the benzoate comprising sodium benzoate.

7. A laser transparent composition as defined in claim 3, wherein each nucleating agent present in the polymer composition is contained in the composition in an amount greater than about 0.001% by weight and in an amount less than about 1.5% by weight, and wherein the salt of the carboxylic acid is present in the composition in relation to the benzoate at a weight ratio of from about 4:1 to about 1:1, such as from about 3:1 to about 1.5:1.

8. A laser transparent composition as defined in claim 1, wherein the polymer composition exhibits a laser transparency of at least 45% at a thickness of 1.5 mm and a laser transparency of at least 50% at a thickness of 1 mm.

9. A laser transparent composition as defined in claim 1, wherein the polymer composition exhibits a tensile strength of greater than about 75 MPa, such as greater than about 120 MPa, such as greater than about 130 MPA, and generally less than about 400 MPA.

10. A laser transparent composition as defined in claim 1, wherein the polymer composition contains the polybutylene terephthalate polymer in an amount of from about 55% by weight to about 90% by weight.

11. A laser transparent composition as defined in claim 1, further comprising a coloring agent.

12. A laser transparent composition as defined in claim 11, wherein the coloring agent comprises a black coloring agent, the black coloring agent being present in the polymer composition in an amount from about 0.1% to about 0.8% by weight.

13. A laser weldable composition as defined in claim 1, wherein the reinforcing fibers comprise glass fibers.

14. A laser weldable composition as defined in claim 1, wherein the reinforcing fibers are present in the polymer composition in an amount from about 10% by weight to about 35% by weight.

15. A molded article formed from the polymer composition as defined in claim 1.

16. An assembly including the molded article as defined in claim 15, the molded article having been laser welded to an adjacent component.

17. A sensor comprising a housing, the housing being made from the polymer composition as defined in claim 1.

18. An advanced driver assistance system including the sensor as defined in claim 17.

19. A method for attaching a polymer article to an adjacent surface comprising:
contacting a molded article made from the laser transparent composition as defined in claim 1 with a laser beam, the laser beam propagating through the molded article and contacting an adjacent surface formed from a laser weldable polymer composition causing a localized temperature increase at the adjacent surface sufficient for the adjacent surface to weld to the molded article.
